(19) United States
(12) Patent Application Publication
(10) Pub. No.: US 2013/0343817 A1
(43) Pub. Date: Dec. 26, 2013

(54) CLAMPING DEVICE

(71) Applicant: OTTO BOCK HEALTHCARE GMBH, Duderstadt (DE)

(72) Inventors: Matthias SCHILLING, Weissenborn-Luderode (DE); Marcus LÜRSSEN, Gottingen (DE)

(21) Appl. No.: 13/913,016

(22) Filed: Jun. 7, 2013

(30) Foreign Application Priority Data
Jun. 11, 2012 (DE) 102012011364.1

(51) Int. Cl. F16B 2/06

(52) U.S. Cl. CPC F16B 2/065
USPC 403/374.3

(57) ABSTRACT

A clamping device having a first clamping part and a second clamping part, between which is formed a space for receiving an object to be clamped, and having at least one clamping screw operable to displace the first and second clamping parts relative to one another. The at least one clamping screw is guided in a through bore in the first clamping part and a thread corresponding to the clamping screw is provided in the second clamping part. The through bore is formed in a bushing which is displaceably mounted in the first clamping part.

### CROSS-REFERENCE TO RELATED APPLICATION

This application claims priority to German Patent Application No. 102012011364.1, filed 11 Jun. 2012, and entitled CLAMPING DEVICE, the disclosure of which is incorporated, in its entirety, by reference.

### TECHNICAL FIELD

The invention relates to a clamping device, having a first clamping part and a second clamping part, between which is formed a space for receiving a clamped object and a clamping gap, and having at least one clamping screw by way of which the clamping parts may be displaced in relation to one another, wherein the clamping screw is guided in a through bore in the first clamping part and a thread corresponding to the clamping screw is provided in the second clamping part.

### BACKGROUND

Clamping devices are used to connect objects to one another, to fix them to one another or to fasten the clamping device itself to an object, for example in order to create limit stops or to enable attachment means to be installed on the object to be clamped.

So that rainwater gutters on house walls can be fixed securely and at a spacing, brackets are known in which a first bracket part has a substantially semicircular shape with a peg to fix it to masonry. Provided on this first bracket part are a hinge, at a first end of the semicircular arc, and a thread, on the opposite side. A second bracket part, also semicircular, is mounted such that it is pivotal in the hinge, and at the opposite end of the second bracket part to the location of mounting is a receiver, typically a thread for a wing screw.

In pipe and rail systems, in particular those made of sensitive materials, there is a need among other things to attach additional components subsequently. For this purpose, open or closed clamping brackets are used. In the case of closed clamping brackets the problem arises that the clamping screws distort and pronounced tensions occur. In the case of open clamping brackets, the pressure plate for the respective application location has to be manufactured specially, so versatile application has not been possible.

### SUMMARY

It is the object of the present invention to provide a clamping device by means of which, in particular also in the case of open clamping brackets, it is possible to form a variable abutment and to compensate for manufacturing tolerances.

According to the invention, this object is achieved by a device having the features of the main claim. Advantageous embodiments and further developments of the invention are described below.

The clamping device according to the invention, having a first clamping part and a second clamping part, between which is formed a space for receiving an object to be clamped and a clamping gap, and having at least one clamping screw by way of which the clamping parts may be displaced in relation to one another, wherein the clamping screw is guided in a through bore in the first clamping part and a thread corresponding to the clamping screw is provided in the second clamping part, provides for the through bore to be made in a bushing which is mounted displaceably in the first clamping part. The displaceable construction of the bushing makes it possible to displace the through bore in the direction of the first clamping part, with the result that there is an adjustable abutment on the first clamping part for the second clamping part. This makes it possible to use a clamping device or a clamping bracket on different objects or at different locations on the object to be clamped without the need for individual manufacture. This results in a saving on work time during manufacture of the clamping device and during assembly of the clamping device on the object to be clamped. Moreover, it is also possible to perform clamping on sensitive objects in the case of which it is necessary for the clamping parts not to tilt in relation to one another but to lie opposite one another in as defined and planar a manner as possible.

A further development of the invention provides for the bushing to be arranged on the first clamping part such that it is displaceable in the longitudinal extent of the clamping screw in order to enable the spacing of the clamping parts in relation to one another to be allowed for. As a result, the size of the clamping gap becomes variable, as a result of which it is possible to adapt the bearing of the clamping parts against the object to be clamped. An advantageous embodiment of the displaceability is produced if the bushing has an external thread that engages in a corresponding internal thread in the first clamping part. This makes it possible to alter the clamping gap by rotating the bushing and thus where necessary to make it larger or smaller. By selecting a fine thread, it is possible to achieve very precise adjustment.

In order to enable or facilitate adjustment of the bushing, in an embodiment of the invention form-fitting elements by way of which movement can be effected by means of a tool are formed or arranged on the bushing. The form-fitting elements may for example take the form of slots or depressions for Allen keys or the like.

The bushing forms an abutment for the clamping as soon as it projects beyond the first clamping part and into the clamping gap between the two clamping parts. This makes it possible, instead of separate clamping parts, or spacing washers which have to be manufactured individually, to allow the bushing to project into the clamping gap in order to provide a dynamic—that is to say movable—abutment for the two clamping parts.

The clamping parts may be constructed separately from one another, giving relatively simple assembly. As an alternative to this, the clamping device is constructed in one piece and has to be adapted to the respective cross section of the object to be clamped by bending it open.

On the end face of the bushing that faces the second clamping part there is formed a surface which is adapted to the opposing surface of the second clamping part. This makes it possible for the bushing to lie on the second clamping part over as large a surface area as possible and to ensure secure association with the abutment formed by the bushing.

In addition to longitudinal displaceability of the bushing within the first clamping part, it is possible for the bushing also to be mounted on the first clamping part such that it is pivotal to a small extent, in order to enable the bushing to bear securely and with as large a surface area as possible against the second clamping part in the event of angular offset, or in the case of a bent-open one-piece clamping device.

An attachment element, or a fastening means for an attachment element, is arranged or formed on at least one of the clamping parts, with the result that additional components may be fastened to the object to be clamped by way of this clamping device.

At least one mark is arranged respectively on the bushing and the first clamping part, by way of which the position of the bushing relative to the first clamping part may be read off. For example, there may be arranged on the bushing and/or the first clamping part a scale which is associated with a corresponding pointing means such that it is easy to see the extent by which the bushing has moved or been displaced from an initial condition.

The bushing may be provided with a knurling which projects beyond the first clamping part, with the result that, even without a tool, a slight movement by rotating the bushing by way of the knurling at the outer periphery, for example a widened bushing head, performs the movement.

### BRIEF DESCRIPTION OF THE DRAWINGS

Exemplary embodiments of the invention will be explained in more detail below with reference to the attached figures, in which:

FIG. 1 shows a cross sectional view through a clamping device according to the prior art;

FIG. 2 shows a cross sectional view through a clamping device according to the invention;

FIG. 2a shows a variant on FIG. 2;

FIG. 3 shows a variant on the invention for angular cross sections;

FIG. 4 shows a variant on the invention for round cross sections;

FIG. 5 shows individual views of a bushing;

FIG. 5a shows a variant on FIG. 5; and

FIGS. 6a-6d show plan views of a device according to FIG. 2a.

### DETAILED DESCRIPTION

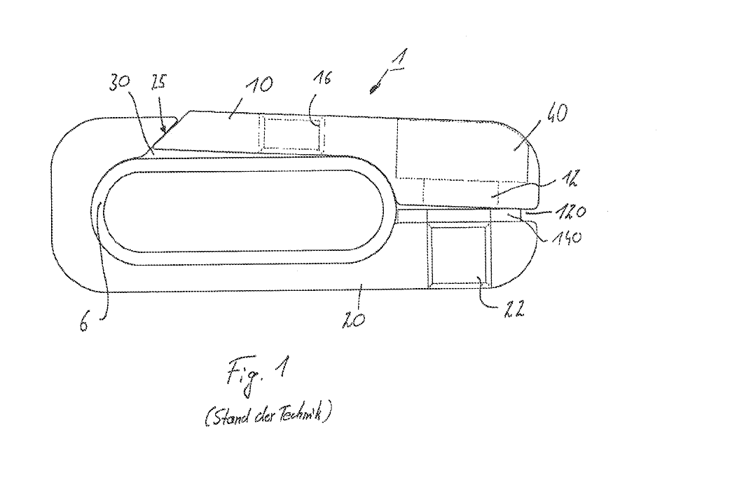

FIG. 1 illustrates a clamping device 1 having a first clamping part 10 and a second clamping part 20. Between the two clamping parts 10, 20 there is formed a space 30 in which an object 6 to be clamped—in the example illustrated a rail of closed hollow cross section—is received. In the first clamping part 10 there is provided, above the object 6 to be clamped, a through bore having a fastening means 16 in the form of a thread, in order to fasten an attachment element (not illustrated) to the first clamping part 10. Also arranged in the first clamping part 10, at the end of a receiving region, is a through bore 12 through which a fastening screw 40 is guided. The fastening screw 40 is supported on a shoulder on the first clamping part 10, next to the through bore 12.

The second clamping part 20 has a receiver which is formed to receive the object 6 to be clamped, in the present case a rail of substantially oval shape. Next to the receiver, a thread 22 into which the clamping screw 40 is screwed is formed in the second clamping part 20, in order to tension the first clamping part 10 in the direction of the second clamping part 20 and hence to clamp and fix between the two clamping parts 10, 20 the object 6 to be clamped. In the region of the clamping screw 40, there is formed a clamping gap 120 by way of which it is possible to enable relative displacement of the first clamping part 10 in relation to the second clamping part 20. The clamping device 1 takes the form of an open clamping bracket, with the result that a release gap 5 is formed between the two clamping parts 10, 20.

Within the clamping gap 120 there is arranged a washer 140 by way of which it is possible to vary the size of the space between the two clamping parts 10, 20 in the region of the clamping gap 120. It can be seen from FIG. 1 that if the washer 140 is dimensioned imprecisely the first clamping part 10 tilts in relation to the second clamping part 20, as a result of which the force fit of the clamping parts 10, 20 on the object 10 to be clamped is less than optimal. Bending forces are exerted on the clamping screw 40 and there is also uneven load on the object 6 to be clamped.

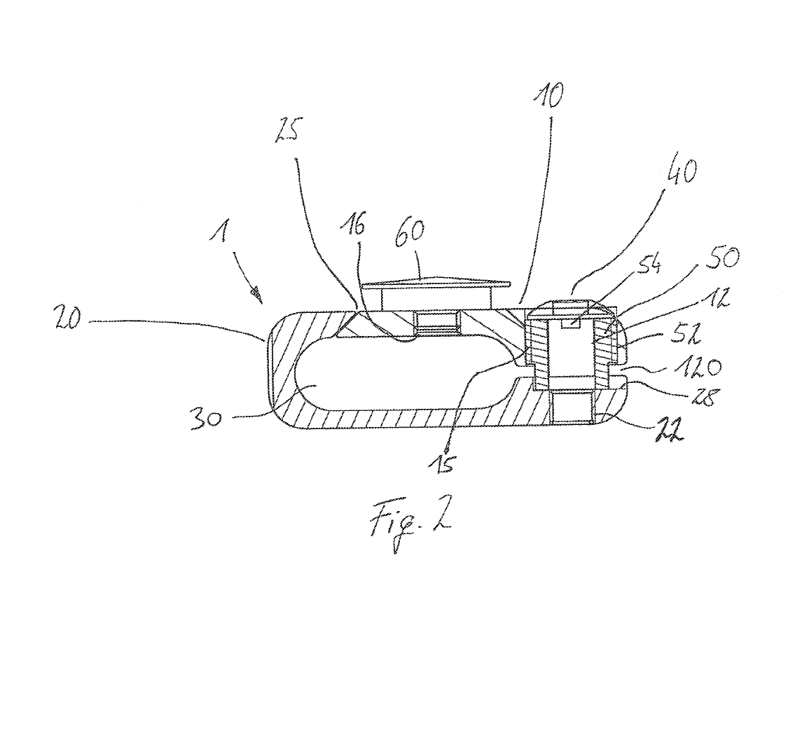

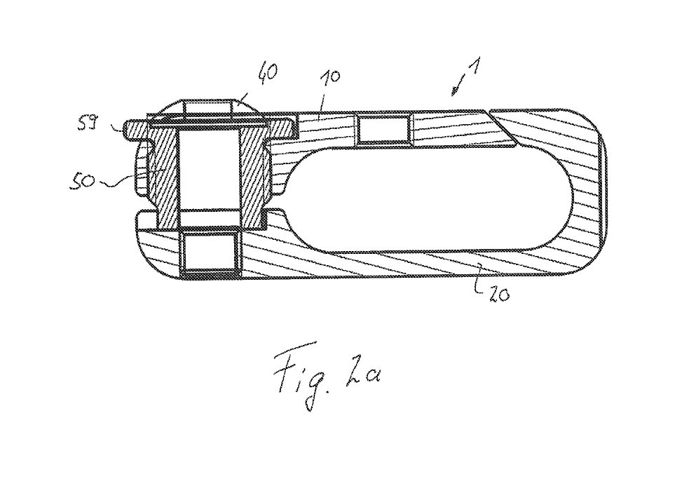

FIG. 2 illustrates an embodiment according to the invention of the clamping device 1, without an object clamped therein. The basic construction of the clamping device 1, which takes the form of a clamping bracket, corresponds substantially to the construction according to FIG. 1. The upper clamping part 1 is constructed as a part-shell and forms a whole with the lower clamping part 20 such that the space 30 for receiving the object to be clamped is substantially entirely surrounded. A release gap 25 is formed between the first clamping part 10 and the second clamping part 20. The clamping screw 40 is arranged at the opposite end of the first clamping part 10 to the release gap 25. The release gap 25 extends obliquely to the longitudinal extent of the clamping screw 40, with the result that the first clamping part 10 can only be displaced away from the second clamping part 20 in the direction of the longitudinal extent of the clamping screw 40 if there is a simultaneous displacement perpendicular to the longitudinal extent of the clamping screw 40. Formed in the first clamping part 10 is a bore having an internal thread 15, into which a bushing 50 having a corresponding external thread 52 is screwed. Formed within the bushing 50 is the through bore 12, through which the clamping screw 40 is guided and engages in the internal thread 22 of the second clamping part 20. The bushing 50 has, at the end associated with the second clamping part, a shoulder and an end face, which is formed to correspond to a surface 28 of the second clamping part. In the present exemplary embodiment, the end face of the bushing 50 and the surface 28 of the second clamping part are constructed to be flat or planar, with the result that the end face 58 bears against the surface 28 over its full surface area. The surface 28 of the second clamping part 20 is machined for example using a milling cutter such that a shoulder is formed between the space 30 and the bushing 50.

Formed between the first clamping part 10 and the second clamping part 20 is the clamping gap 120, which may be altered by rotating the bushing 50 within the internal thread 15. The further the bushing 50 is displaced in the direction of the second clamping part 20 using a tool by way of form-fitting elements 54, the larger the clamping gap 120 becomes; if the bushing 50 is turned in the other direction the clamping gap 120 becomes smaller.

The fastening means 16 is formed on the first clamping part 10 and takes the form of an internal thread for a screwed-in attachment element 60. Different components may easily be fastened to the attachment element 60 to enable connection to the object to be clamped (not illustrated), for example a rail.

The fact that the bushing 50 is formed such that it may be displaced in its position relative to the first clamping part 10 makes it possible to achieve an alteration in the clamping gap 120, with the result that an abutment is created by way of the end face of the bushing 50 on the correspondingly shaped surface 28 of the second clamping part 20. The internal thread 15 and the external thread 52 preferably take the form of fine threads in order to enable fine adjustment of the bushing 50, with the result that the extent to which the bushing 50 projects into the clamping gap 120 can be adjusted precisely, to enable the object to be clamped in the optimum possible way. By way of the adjustable bushing 50, it is possible in particular to displace the clamping device 1 on the object to be clamped when the contours are curved without the need to provide separate washers; rather, all that is required is to rotate the bushing 50 in the respective direction, which can be done easily and simply.

FIG. 2a illustrates a variant on FIG. 2, in which, instead of form-fitting elements 54 within the bushing 50, movement of the vertical position and hence of the abutment formed by the bushing 50 are moved by way of a knurling 59. The knurling 59 is arranged on a shoulder projecting laterally beyond the first clamping part 10, with the result that easy adjustability is ensured.

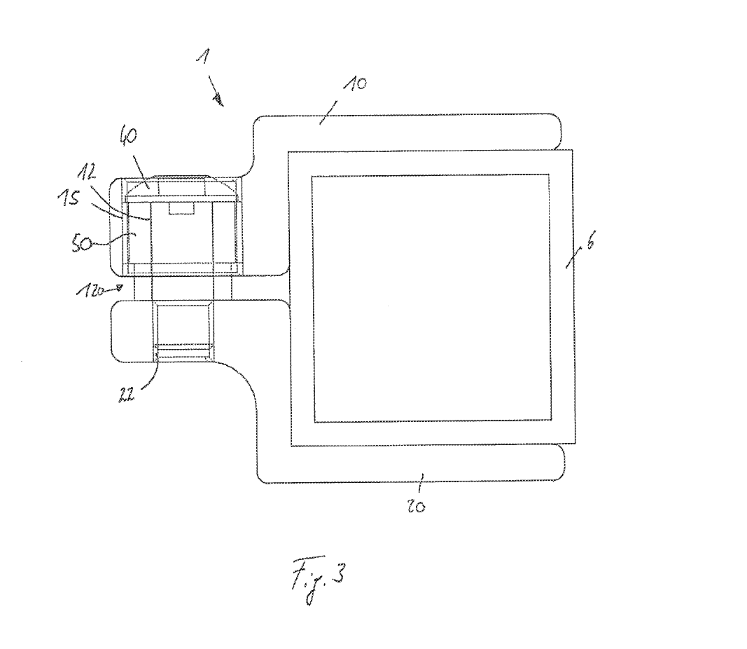

FIG. 3 illustrates a variant on the clamping device 1 in which the clamping parts are of substantially the same shape. In the first clamping part 10, the bushing 50 is guided in the internal thread 15 and the clamping screw 40 is guided in the through bore 12 and engages in the corresponding internal thread 22 in the second clamping part. In contrast to the embodiment according to FIG. 2, the clamping parts 10, 20 do not take the form of clamping shells that entirely surround the object 6 to be clamped but of an open clamping device which grasps the object 6 to be clamped, which has an angular cross section, on three sides and clamps it on mutually opposing sides.

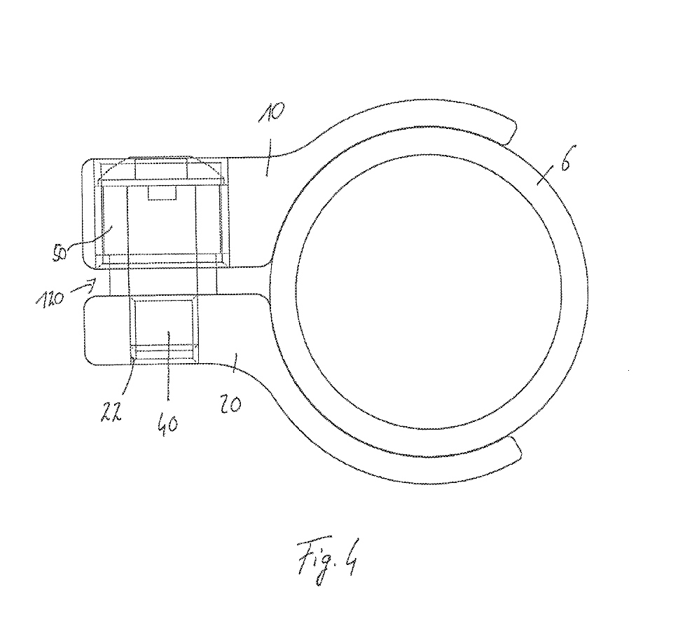

A further variant on the invention is illustrated in FIG. 4, in which, instead of the object 6 to be clamped being grasped in an almost enclosed manner, the object 6, having a circular cross section, is grasped around only part thereof. On the opposite side of the object 6 to be clamped to the clamping gap 12 there is a space, with the result that the opposite ends of the clamping parts 10, 20 to the clamping screw 40 do not touch one another. Because the bushing 50 is movable and adjustment of the clamping gap width is consequently possible, adaptation to the object to be clamped can be performed quickly and simply.

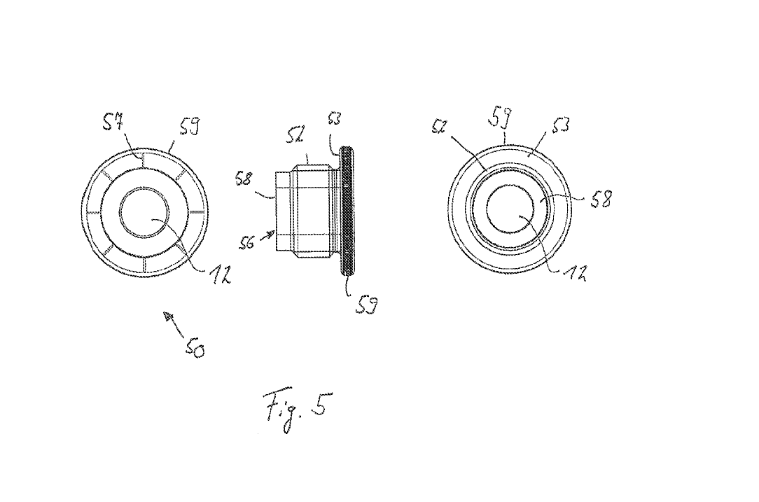

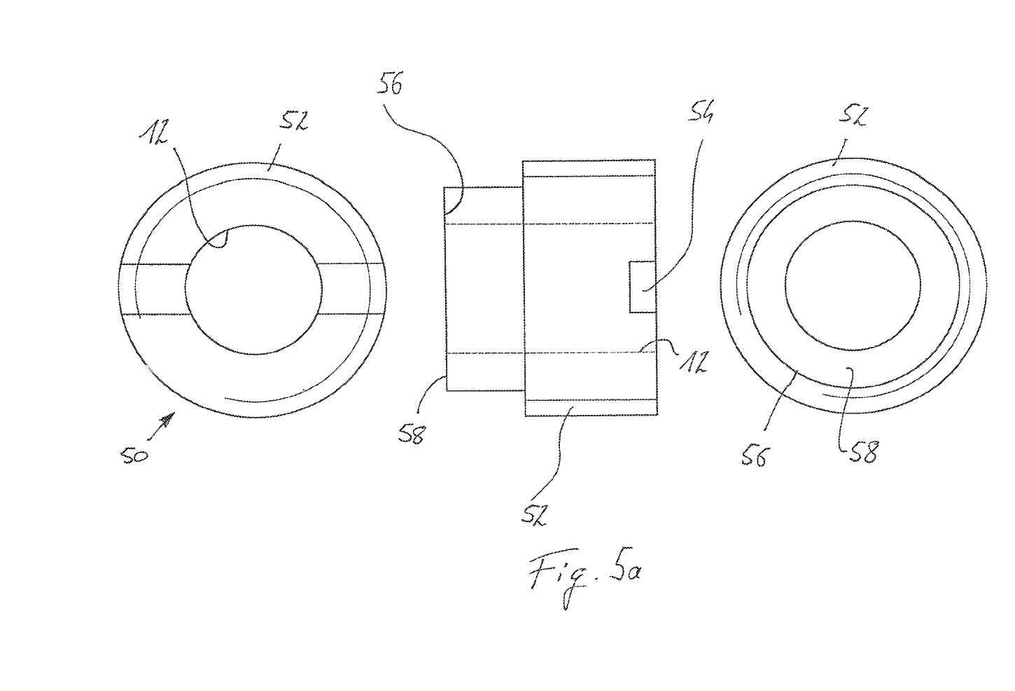

FIG. 5 shows a bushing 50 as an individual illustration in different views. The left-hand illustration shows a plan view of the bushing 50 in which the through bore 12 can be seen in the centre. Marks 57 are made on the upper side of the screw-in bushing 50 in order to improve the adjustability of the bushing and to enable better recognition to be achieved of the position of the bushing 50 relative to the first clamping part 10.

The middle illustration shows a side view of the bushing 50, turned through 90°. The flat end face 58 of the bushing 50, having a flat surface 56, can be seen. An external thread 52, preferably a fine thread, can also be seen. Toward the end face 58, the bushing has a smaller diameter than the external diameter of the external thread 52; on the side of the external thread 52 remote from the end face 58 there is formed a shoulder 53, on the external periphery of which a knurling 59 is made in order to enable the bushing 50 to be moved even without a tool.

The right-hand illustration in FIG. 5 shows a bottom view with the end face 58, the external thread 52, the shoulder 53, the knurling 59 and the central through bore 12.

FIG. 5a shows a variant on the bushing 50 according to FIG. 5. Instead of a shoulder 53 with a knurling 59, a form-fitting element 54 in the shape of a slot is arranged on the side of the bushing 50 remote from the end face 58, which is opposite the second clamping part, with the result that the bushing 50 is movable relative to the first clamping part 10 by way of a screwdriver. The bushing 50 may thus be screwed completely into the first clamping part 10 in the manner of a headless screw, without any constraint by the shoulder.

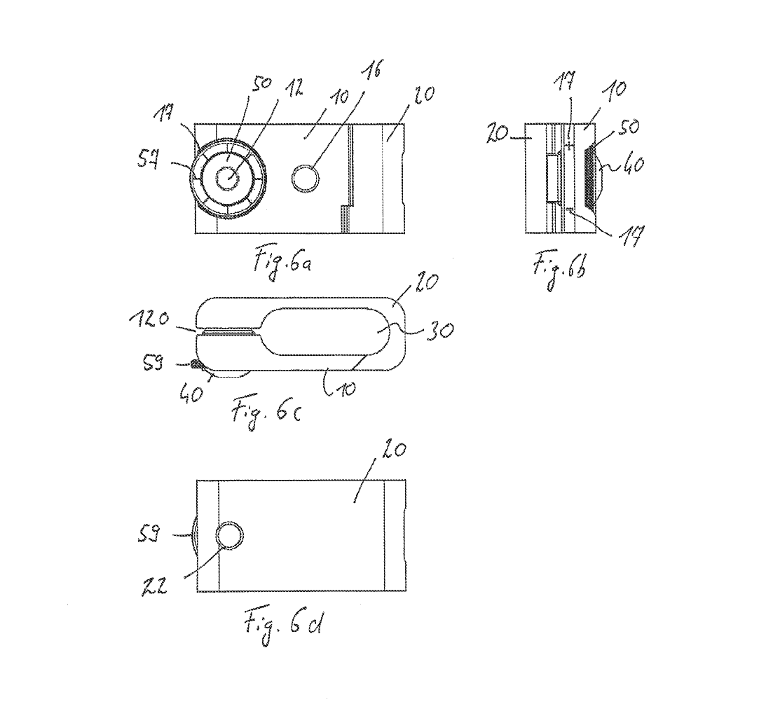

FIGS. 6a to 6d illustrate different views of the clamping device according to FIG. 2a. in FIG. 6a it can be seen that the shoulder 53 having the knurling 59 projects beyond the edge of the first component 10, with the result that there is on the short side of the device an overhang which enables the bushing 50 to be adjusted easily. Similarly, marks 57 can be seen on the bushing 50 and marks 17 can be seen on the first clamping part 10. FIG. 6b shows further marks 17 on the short side of the first clamping part 10. The marks 17 allow an increase or a reduction in the spacing of the clamping gap 120 to be displayed.

FIG. 6c shows the clamping device 1 in a side view with the space 30, the clamping gap 120 and the clamping screw 40. FIG. 6d shows a bottom view of the clamping device 1, in which the second clamping part 20 with the internal thread 22 and the projecting edge of the bushing 50 with the knurling 59 can be seen.

What is claimed is:

1. A clamping device, having a first clamping part and a second clamping part, between which is formed a space for receiving an object to be clamped and a clamping gap, and having at least one clamping screw by way of which the first and second clamping parts may be displaced in relation to one another, wherein the at least one clamping screw is guided in a through bore in the first clamping part and a thread corresponding to the at least one clamping screw is provided in the second clamping part, wherein the through bore is made in a bushing which is mounted displaceably in the first clamping part.

2. The clamping device according to claim 1, wherein the bushing is arranged in the first clamping part such that it is displaceable in a direction along a longitudinal dimension of the at least one clamping screw.

3. The clamping device according to claim 1, wherein the bushing has an external thread that engages in a corresponding internal thread in the first clamping part.

4. The clamping device according to claim 1, wherein form-fitting elements for receiving movement elements are provided in the bushing.

5. The clamping device according to claim 1, wherein the bushing projects into the clamping gap and forms an abutment for the second clamping part.

6. The clamping device according to claim 1, wherein the first and second clamping parts are constructed separately.

7. The clamping device according to claim 1, wherein the clamping device is constructed in one piece.

8. The clamping device according to claim 1, wherein an end face of the bushing that faces the second clamping part therein is formed a surface which is adapted to a surface of the second clamping part.

9. The clamping device according to claim 1, wherein the bushing is mounted in the first clamping part such that it is pivotal.

10. The clamping device according to claim 1, wherein an attachment element, or a fastening means for an attachment element, is arranged or formed on at least one of the first and second clamping parts.

11. The clamping device according to claim 1, wherein at least one mark is arranged respectively on the bushing and the first clamping part, by way of which a position of the bushing may be read.

12. The clamping device according to claim 1, wherein the bushing is provided with a knurling.

13. A clamping device, comprising:
a first clamping part having a through bore;
a second clamping part having a threaded portion;
a space formed between the first and second clamping parts and configured to receive an object to be clamped;
at least one clamping screw operable to displace the first and second clamping parts relative to each other, the at least one clamping screw extending through the through bore in the first clamping part and threadably engaging the threaded portion of the second clamping part;
wherein the through bore is formed in a bushing which is displaceably mounted in the first clamping part.

14. The clamping device according to claim 13, wherein the bushing is arranged in the first clamping part such that it is displaceable in a direction along a longitudinal dimension of the at least one clamping screw.

15. The clamping device according to claim 13, wherein the bushing has an external thread that engages in a corresponding internal thread in the first clamping part.

16. The clamping device according to claim 13, wherein the bushing includes a plurality of form-fitting elements for receiving movement elements.

17. The clamping device according to claim 13, wherein the bushing projects into the space and forms an abutment for the second clamping part.

18. The clamping device according to claim 13, wherein the bushing is pivotally mounted in the first clamping part.

19. A clamping device, comprising:
a first clamping part having a through bore;
a bushing mounted to the first clamping part and forming the through bore;
a second clamping part;
at least one clamping screw extending through the through bore and threadably engaging the second clamping part, wherein rotating the at least one clamping screw displaces the first and second clamping parts relative to each other to adjust a clamping force applied to an object positioned between the first and second clamping parts.

20. The clamping device according to claim 20, wherein the bushing is adjustably mounted in the first clamping part and displaceable in a direction along a longitudinal dimension of the at least one clamping screw.
